(19) United States
(12) Patent Application Publication
(10) Pub. No.: US 2008/0045617 A1
(43) Pub. Date: Feb. 21, 2008

(54) Method for recycling a cross-linked polymer

(75) Inventors: Toshiharu Goto, Hitachi (JP); Tokanori Yamazaki, Mito (JP); Masaaki Yoshida, Utsunomiya (JP); Yasuhrio Funayama, Utsunomiya (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 11/882,600

(22) Filed: Aug. 2, 2007

(30) Foreign Application Priority Data
Aug. 4, 2006 (JP) 2006-213554

(51) Int. Cl. C08J 11/16

(52) U.S. Cl. 521/40.5

(57) ABSTRACT

A cross-linked polymer is recycled by decomposing a C—C bond by an oxidative decomposition reaction using a nitrogen oxide in a supercritical carbon dioxide. A reaction temperature, a pressure and a reaction time are controlled such that a nitrogen oxide is sorbed at a branch point of a C—C bond of the cross-linked polymer. As a result, the branch point of the C—C bond is preferentially oxidized to cleave the C—C bond.

The present application is based on Japanese Patent Application No. 2006-213554 filed on Aug. 4, 2006, the entire contents of which are incorporated herein by reference.

### BACKGROUND OF THE INVENTION

1. Field of the Invention

The present invention relates to a method for recycling a cross-linked polymer, in particular, to a method for recycling a cross-linked polymer, by which it is possible to provide the cross-linked polymer with the thermo plasticity, thereby realizing the recycling of the cross-linked polymer having no thermo plasticity that is difficult to be recycled, and wound up in a landfill in large quantities.

2. Related Art

A polymer having sequential carbon-carbon bonds (C—C bonds) is widely used for a coating material for electric wires and cables, a connector material, a hot water supply pipe material, a heat storage material or the like, as represented by a polyolefin system polymer. Molding properties of such a polymer is strongly affected by a degree of branch connection of the C—C bond including a cross-linked structure.

In particular, the cross-linked polymer does not melt by heat, since the cross-linked polymer has a three-dimensional network, so that it is difficult to reuse a disposed cross-linked polymer by the molding process. Accordingly, the recycling of the disposed cross-linked polymer is difficult, and most of the used cross-linked polymer materials are disposed by earth filling or by incineration.

On the other hand, the cross-linked polymer has been recently studied for the purpose of the recycling, in view of environmental issues such as surge of consciousness of a global earth environmental protection, exhaustion of resource. One of techniques for recycling the cross-linked polymer is to transform the cross-linked polymer in fine particles, and collect them as a pulverized fuel having a good combustion efficiency, so as to recycle the cross-linked polymer as a fuel.

Another technique for recycling the cross-linked polymer is to heat the cross-linked polymer transformed in fine particles at a high temperature, so as to convert the cross-linked polymer into an oil by heat decomposition, and to collect the oil as a fuel, as disclosed by Japanese Patent Laid-Open No. 10-160149.

In addition, a still another technique for recycling the cross-linked polymer is studied. In this technique, the cross-linked polymer transformed in fine particles is mixed with an uncross-linked resin, such that the cross-linked polymer can melt, and a product can be manufactured by extrusion molding.

Further, other techniques for recycling the cross-linked polymer, in which the cross-linked polymer is decomposed by using a supercritical water and a subcritical water, are proposed recently, as disclosed by Japanese Patent Laid-Open No. 6-279762 and Japanese Patent Laid-Open No. 10-24274.

However, when the cross-linked polymer is heat decomposed by using the aforementioned conventional techniques for recycling the cross-linked polymer, a molecular weight is greatly lowered. As a result, a decomposition reaction advances until the cross-linked polymer is converted into a wax or an oil of a low molecular weight in most cases. Therefore, it is difficult to realize the material recycle in which the cross-linked polymer is converted into an original polymer before the crosslinking.

On the other hand, there are proposed several techniques for selectively cleaving the cross-link. For example, there is a technique for providing a thermoplastic sulfur cross-linked polymer by cleaving only a small sulfur bond having a small bonding energy with using a difference in a bonding energy of chemical bonding. Further, there is a technique for providing a thermoplastic silane cross-linked polymer by selectively cleaving a siloxane bond with using a chemical reaction in a supercritical alcohol.

However, these techniques are techniques of providing the cross-linked polymer with the thermo plasticity by using a difference in chemical constitution between a part constituting a main chain of the polymer and a sulfur bond part or a siloxane bond part which constitutes the cross-link. For example, the cross-link polymer cross-linked by using a peroxide cross-link method, an electron beam cross-link method or the like is cross-linked by the C—C bond that is the same chemical bond as that included in a main chain of most of polymers.

Therefore, since the chemical bond of the cross-linking part is common to that of the main chain of the polymer, it is difficult to cleave the cross-link prior to other parts in order to recycle the cross-liked polymer as a thermoplastic polymer.

In addition, the Inventors proposed an approach to cleave a molecular chain of a disposed polymer by an oxidative decomposition reaction using a nitrogen oxide in a supercritical carbon dioxide, to provide a middle molecule substance or a small molecule substance, as disclosed by Japanese Patent Laid-Open No. 2002-212334.

However, when the cross-linked polymer is provided with the thermo plasticity by using this technique, a molecular weight of a product thus obtained is significantly decreased, and applications of the product as high molecular material are limited. Therefore, it is difficult to recycle the cross-linked polymer according to this technique.

As described above, a difference in the chemical bond energy between the cross-linking part and the main chain of the polymer is small in the cross-linked polymer, so that it is difficult to preferentially cleave the cross-link in order to recycle the cross-linked polymer as a thermoplastic polymer according to the aforementioned techniques.

For obtaining a molded product which satisfies more complicated and higher required properties that the product obtained by using the conventional techniques, it is necessary to selectively cleave a branching point of the C—C bond, to improve a workability of the polymer that was conventionally difficult to be processed. The present invention is achieved for solving the above problems in view of such actual circumstances

### THE SUMMARY OF THE INVENTION

Accordingly, an object of the present invention is to provide a method for recycling a cross-linked polymer material, by which the cross-linked polymer is provided with a thermo plasticity to enable the recycling, nevertheless most of the cross-linked polymers have been disposed in large quantities by earth filling or by incineration due to their difficulties in recycling.

Another object of the present invention is to provide a method for recycling a cross-linked polymer material, by which the cross-linked polymer is provided with the thermo plasticity to enable the material recycling, with keeping a high molecular weight component of the polymer before the cross-linking part, to preferentially cleave the cross-link by preferentially decomposing the branching point of the C—C bond.

According to a first feature of the invention, a method for recycling a cross-linked polymer, in which a C—C bond of the cross-linked polymer is cleft by an oxidative decomposition reaction using a nitrogen oxide, comprises a step of:

keeping the cross-linked polymer in a supercritical carbon dioxide at a temperature not greater than 100° C. for 10 hours or more to preferentially oxidize a branch point of the C—C bond.

According to a second feature of the invention, in the method for recycling a cross-linked polymer, the cross-linked polymer comprises a polyolefin including a tertiary carbon and a quaternary carbon, the polyolefin being cross-linked by a peroxide cross-link, an electron beam cross-link, or a silane-water cross-link.

According to a third feature of the invention, in the method for recycling a cross-linked polymer, the cross-linked polymer comprises an ethylene copolymer including a tertiary carbon and a quaternary carbon, the ethylene copolymer being cross-linked by a peroxide cross-link, an electron beam cross-link, or a silane-water cross-link.

According to a fourth feature of the invention, a method for recycling a cross-linked polymer comprises steps of:

providing the cross-linked polymer in a reaction container;

substituting an air in the reaction container for a carbon dioxide;

adding a nitrogen oxide and another carbon to the reaction container; and

keeping the reaction container under a pressure not less than a supercritical pressure of the carbon dioxide at a temperature of about 85° C. for 10 hours or more to cleave a C—C bond of the cross-linked polymer by preferentially oxidizing a branch point of the C—C bond.

According to a fifth feature of the invention, a method for recycling a cross-linked polymer comprises steps of:

providing the cross-linked polymer in a reaction container;

substituting an air in the reaction container for a carbon dioxide;

adding a nitrogen oxide and another carbon to the reaction container;

sorbing the nitrogen oxide in the cross-linked polymer by keeping the reaction container under a pressure not greater than a supercritical pressure of the carbon dioxide to; and

reacting the cross-linked polymer with the nitrogen oxide by keeping the carbon dioxide in the reaction container under a pressure not less than the supercritical pressure of the carbon dioxide, to cleave a C—C bond of the cross-linked polymer by preferentially oxidizing a branch point of the C—C bond.

According to a sixth feature of the invention, in the method for recycling a cross-linked polymer, the nitrogen oxide is at least one of a nitrogen dioxide and a dinitrogen tetraoxide, and a reactivity of the nitrogen oxide is controlled by adjusting the pressure and the temperature.

According to the present invention, it is possible to preferentially decompose the branching point of the C—C bond which constitutes the cross-linking part of the cross-linked polymer, most of which has been disposed in large quantities by earth filling or by incineration due to its difficulties in the recycling. Since the cross-link is preferentially decomposed with keeping a state that the high molecular weight component of the polymer before the cross-linking is not completely lost, there is an excellent effect that a reproduced resin thus obtained can be recycled as a polymer material so that its industrial value is significantly high.

### DESCRIPTION OF THE PREFERRED EMBODIMENTS

Next, preferred embodiments according to the present invention will be explained in more detail in conjunction with the appended drawings.

In a first preferred embodiment according to the present invention, a cross-linked polymer is put into a reaction container, a carbon dioxide in the reaction container is kept at a supercritical state, to which a nitrogen oxide is added, and a reaction temperature in the reaction container is kept at a temperature not greater than 100° C. for 10 hours or more. As a result, a branch point of a C—C bond of the cross-linked polymer is preferentially oxidized (in particular, a bridge part is oxidized when the cross-linked polymer has a bridge structure), so that the C—C bond is preferentially cleft.

Further, in a second preferred embodiment according to the present invention, it is possible to conduct the oxidative reaction by separate steps in place of conducting the oxidative reaction at a temperature not greater than 100° C. for a long time (e.g. 10 hours or more), namely a first step of sorbing the nitrogen oxide by the cross-linked polymer, and a second step of reacting the cross-linked polymer sorbing the nitrogen oxide in the supercritical carbon dioxide at a temperature not less than 100° C. for a short time (e.g. 1 hour) to cleave the C—C bond.

In more concrete, in the second preferred embodiment according to the present invention, a cross-linked polymer is put into a reaction container, to which a carbon dioxide and a nitrogen oxide arc added, the reaction container is kept under a pressure not greater than a supercritical state of the carbon dioxide, so that the nitrogen oxide is sorbed (absorbed, adsorbed) by the cross-linked polymer. Thereafter, the carbon dioxide is kept at a supercritical pressure, so that the cross-linked polymer reacts with the nitrogen oxide at a temperature not less than 100° C. As a result, the branch point of the C—C bond of the cross-linked polymer is preferentially oxidized (in particular, a bridge part is oxidized when the cross-linked polymer has a bridge structure), so that the C—C bond is preferentially cleft.

As for the nitrogen oxide, a nitrogen dioxide, a dinitrogen tetraoxide, a nitric oxide, a dinitrogen oxide, a dinitrogen trioxide or the like may be used alone or combined with each other, as well as combined with an oxygen, an ozone, a hydrogen peroxide, a sulfur dioxide or the like. It is preferable to use the nitrogen dioxide or the dinitrogen tetraoxide. In the oxidative decomposition reaction using the nitrogen oxide or the like, a metal catalyst such as Ru, Rh, Pd, Pt, Ti, V, Cr, Mn, Fe, Co, Ni, Cu or the like, a radical initiator such as benzoyl peroxide, azobisisobutyronitrile, N-hydroxyphthalimide or the like, or an organic acid such as formic acid, acetic acid or the like may be added for the reaction.

The “sorption” in the present application means that a material such as nitrogen oxide dissolved or impregnated in the polymer is incorporated with the polymer.

It is preferable to keep the reaction temperature of not less than 100° C. at the second step equal to or less than a heat decomposition temperature or a depolymerization temperature. Herein, the temperature equal to or less than the heat decomposition temperature or the depolymerization temperature is not greater than 360° C.

The cross-linked polymer in the present invention is a polymer having sequential C—C bonds, in which the branch point of the C—C bond is a polyolefin or an ethylene copolymer, which has a chemical structure cross-linked by means of a peroxide cross-link, an electron beam cross-link, a silane-water cross-link or the like.

Herein, the polymer having the sequential C—C bonds is a polymer represented by a polyethylene. The branch point of the C—C bond in the polymer is, for example, a branch point between a side chain and a main chain or a cross-linking part of the polyethylene.

In general, it is difficult to preferentially cleave a bond with a secondary carbon or a tertiary carbon, based on only a difference in substitution degree of one of carbons bonded by the C—C bond (in other words, the primary carbon, the secondary carbon, and the tertiary carbon).

However, according to the present invention, it is possible to preferentially start the reaction from the bond with the secondary carbon or the tertiary carbon, by dispersing NO₂ radicals in the carbon dioxide.

It is assumed that this reaction would utilize a fact that a secondary carbon radical and a tertiary carbon radical are more stable than a primary carbon radical.

Further, it is expected that such a reaction can be used for providing a cross-linked polymer wit the thermo plasticity, particularly for the cross-linked polymer having the C—C bond in the cross-linked structure that is cross-linked by the peroxide cross-link or the electron beam cross-link.

In other words, as shown in (Formula 1], a structure of the part constituting the cross-link has a quaternary carbon in a polymer molecular chain (main chain) of the secondary carbon. It is assumed that the C—C bond of the cross-linking part is cleft to generate a radical.

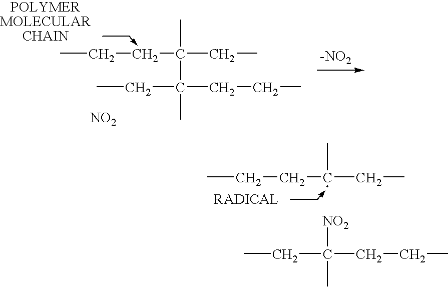

Therefore, it is expected that the branch point of the C—C bond in the cross-linked structure preferentially reacts. As a result, the cross-linked structure is preferentially cleft, so that it is possible to recycle the cross-linked polymer as a reclaimed polymer by suppressing a decomposition of the main chain of the polymer, namely, the degradation of the polymer to minimum.

In addition, it is assumed that the present invention may be effectively used for example in a case that an alkoxysilane is grafted on the polymer by using a vinyl silane, and cross-linked by using a condensation reaction of a silanol group in the presence of moisture, since the branch point of the C—C bond is generated. Further, as for the silane-water cross-linked polymer, since a bonding energy of a C—Si bond is smaller than that of the C—C bond, it is assumed that the C—Si bond can be selectively cleft under the reaction conditions of the present invention.

For the above described reasons, it is possible to selectively cleave the cross-link of the polymer, even when the peroxide cross-link and the cross-link by the vinyl silane are mixed with each other, for example.

Since the nitrogen dioxide (NO₂) is a substance which is in a chemical equilibrium condition with the dinitrogen tetraoxide (N₂O₄) and the equilibration can be controlled by a pressure and a temperature, it is easy to control the reaction by using the nitrogen dioxide and the dinitrogen tetraoxide.

As for the carbon dioxide, a critical pressure is 7.38 MPa, and a critical temperature is 31.1° C. Since the critical points in pressure and temperature of the carbon dioxide are low, the carbon dioxide can be used as a supercritical fluid in such a low temperature condition that the chemical reaction caused by the radical can be suppressed. Therefore, it is effective to use the carbon dioxide, when a selective decomposition reaction is conducted by using a high reactive substance such as the nitrogen dioxide.

In the first preferred embodiment, the reaction temperature is preferably not greater than 100° C, and more preferably not greater than 85° C., for the purpose of the material recycling. The reaction time is preferably not less than 10 hours. According to these conditions, the tertiary carbon or the quaternary carbon is preferentially made radical, so that the carbon bond is cleft.

When the reaction temperature exceeds 100° C., the polymer is randomly decomposed, so that the molecular weight is significantly decreased and parts other than the cross-linking part are decomposed. As a result, a mechanical strength, an elongation and the like of the polymer are remarkably deteriorated, so that it is difficult to reuse the reclaimed material as a polymer. Accordingly, the reaction temperature is not greater than 100° C., and more preferably not greater than 85° C. Under this temperature condition, a reaction rate is decreased, so that the reaction time is 10 hours or more.

In the second preferred embodiment according to the present invention, the tertiary carbon or the quaternary carbon may be made radical to preferentially cleave the branch point of the C—C bond. In a reaction container, a carbon dioxide and a radical of a nitrogen oxide or the like are dissolved in the cross-linked polymer or sorbed by the cross-linked polymer under a pressure not greater than a supercritical pressure at a relatively low temperature (e.g. not greater than 100° C.) for a short time (e.g. 1 hour). Thereafter, the cross-linked polymer is once taken out from the reaction container, and excessive nitrogen oxides arc removed from the polymer. Then, the cross-linked polymer is heated at a relatively high temperature (e.g. not less than 100° C.) for a short time (e.g. 1 hour) in the supercritical carbon dioxide to preferentially cleave the branch point of the C—C bond of the cross-linked polymer.

So as to effectively cleave the cross-linking bond, the cross-linked polymer may be provided in a form of pellet or powder by crushing.

Further, so as to accelerate the decomposition, more than two kinds of the peroxide and the nitrogen oxide may be mixed, and an inert gas other than the carbon dioxide may be mixed.

Herein, the polymer having the sequential C—C bonds may be a polyolefin such as polyethylene, polypropylene, and an ethylene copolymer such as chlorinated polyethylene, ethylene-vinyl acetate copolymer, ethylene-ethyl acrylate copolymer, ethylene-propylene rubber, ethylene-octene rubber, or the like.

### EXAMPLES

Next, examples of the present invention and comparative examples will be explained below.

### Example 1

A peroxide cross-linked polyethylene with a gel fraction of 85% was molded to have a sheet shape with a thickness of 1 mm, and crushed into a form of pellet with a side length of 2 to 3 mm. This pellet of 6.0 g was filled in an autoclave (a reaction container) of 200 ml. Thereafter, an air in the autoclave was substituted for a carbon dioxide, and a nitrogen dioxide (NO₂) of 1.0 g together with a carbon dioxide is added thereto. The oxidative reaction was conducted under a pressure of 19 MPa at a temperature of 85° C. for 18 hours.

The reaction container was cooled after the reaction, and the polymer was collected as a sample. A molecular weight distribution and a gel fraction serving as an index of a cross-linking degree of the sample were measured.

The measuring conditions are as follows.

The molecular weight distribution of the sample was measured by using an o-dichlorobenzene as a solvent by means of a high temperature GPC (Gel Permeation Chromatography). As a result, the collected product in which a high molecular weight component of not less than 300,000 remains, even when a number average molecular weight is decreased, is evaluated as ◯, and the collected product in which the high molecular weight component does not remain is evaluated as ×.

The gel fraction of the sample was measured in accordance with a standard of JIS C3005. The sample after the reaction was immersed in a xylene of 100° C. for 24 hours, and the remained sample was vacuum-dried. The gel fraction was calculated from a ratio of a dehydrated weight to an initial weight.

### Example 2

Example 2 is similar to the Example 1, except that the silane cross-linked polyethylene is used in place of the peroxide cross-linked polyethylene used in the Example 1.

### Example 3

Example 3 is similar to the Example 1, except that the ethylene vinyl acetate cross-linked by the electron beam is used in place of the peroxide cross-linked polyethylene used in the Example 1.

### Example 4

A peroxide cross-linked polyethylene with a gel fraction of 85% was molded to have a sheet shape with a thickness of 1 mm, and crushed into a form of pellet with a side length of 2 to 3 mm. This pellet of 0.5 g was filled in an autoclave of 50 ml. Thereafter, an air in the autoclave was substituted for a carbon dioxide, and a nitrogen dioxide (NO₂) of 1.2 g together with carbon dioxide is added thereto. The NO₂ was sorbed in the peroxide cross-linked polyethylene under a pressure of 4 MPa at a temperature of 60° C. for 1 hour. Thereafter, the polyethylene was taken out from the autoclave, and then heated again with being pressurized. Namely, the oxidative reaction was conducted under a pressure of 14 MPa at a temperature of 140° C. for 1 hour.

The reaction container was cooled after the reaction, and the polymer was collected as a sample. A molecular weight distribution and a gel fraction serving as an index of a cross-linking degree of the sample were measured.

The measuring conditions are as follows.

The molecular weight distribution of the sample was measured by using an o-dichlorobenzene as a solvent by means of a high temperature GPC (Gel Permeation Chromatography). As a result, the collected product in which a high molecular weight component of not less than 300,000 remains even if a number average molecular weight is decreased is evaluated as ◯, and the collected product in which the high molecular width component does not remain is evaluated as ×.

The gel fraction of the sample was measured in accordance with a standard of JIS C3005. The sample after the reaction was immersed in a xylene of 110° C. for 24 hours, and the remained sample was vacuum-dried. The gel fraction was calculated from a ratio of a dehydrated weight to an initial weight.

### Example 5

Example 5 is similar to the Example 4, except that the reheating and the pressurization after taking out the polyethylene were conducted under a pressure of 14 MPa at a temperature of 140° C. for 15 minutes.

### Comparative Example 1

A comparative example 1 is similar to the Example 1, except that NO₂ is not added.

### Comparative Example 2

A comparative example 2 is similar to the Example 1, except that a temperature of the reaction container (autoclave) was 250° C.

### Comparative Example 3

A comparative example 3 is similar to the Example 2 using the silane cross-linked polyethylene, except that N0₂ is not added similarly to the comparative example 1.

### Comparative Example 4

A comparative example 4 is similar to the Example 3 using the ethylene vinyl acetate cross-linked by the electron beam, except that NO₂ is not added similarly to the comparative example 1.

### Comparative Example 5

A comparative example 5 is similar to the Example 1, except that a temperature of the reaction container (autoclave) was 140° C. and a reaction time was 2 hours.

Experimental results of the Examples I to S and the comparative examples I to 5 are shown in Table 1.

TABLE 1
TABLE 1

| | | | Decomposition conditions | | | | |
|---|---|---|---|---|---|---|---|
| | | | Additive | | | Properties | |
| | | | amount | | | of the product | |
| | | | of NO₉ | Temperature | Pressure | Molecular | Gel |
| Item | | | (g) | (° C.) | (MPa) | weight | Fraction |
| Example | 1 | Peroxide cross-linked polyethylene | 1.0 | 85 | 18 | ◯ | 0 |
| | | (Gel fraction of 90%, based on low density polyethylene) | | | | | |
| | 2 | Silane cross-linked polyethylene | 1.0 | 86 | 18 | ◯ | 0 |
| | | (Gel fraction of 70%, based on straight-chain polyethylene) | | | | | |
| | 3 | Ethylene vinyl acetate cross-linked by electron beam | 1.0 | 85 | 18 | ◯ | 0 |
| | | (Gel fraction of 50%, based on ethylene vinyl acetate | | | | | |
| | | copolymer) | | | | | |
| | 4 | Peroxide cross-linked polyethylene | 1.2 | 140 | 14 | ◯ | 0 |
| | | (Gel fraction of 90%, based on low density polyethylene) | | | | | |
| | 5 | Peroxide cross-linked polyethylene | 1.2 | 140 | 14 | ◯ | 10 |
| | | (Gel fraction of 80%, based on low density polyethylene) | | | | | |
| Comparative | 1 | Peroxide cross-linked polyethylene | 0 | 80 | 18 | — | 90 |
| Example | | (Gel fraction of 90%, based on low density polyethylene) | | | | | |
| | 2 | Peroxide cross-linked polyethylene | 0.5 | 250 | 18 | X | 0 |
| | | (Gel fraction of 90%, based on low density polyethylene) | | | | | |
| | 3 | Silane cross-linked polyethylene | 0 | 80 | 18 | — | 70 |
| | | (Gel fraction of 70%, based on straight-chain low density | | | | | |
| | | polyethylene) | | | | | |
| | 4 | Ethylene vinyl acetate cross-linked by electron beam | 0 | 80 | 18 | — | 60 |
| | | (Gel fraction of 60%, based on ethylene vinyl acetate | | | | | |
| | | copolymer) | | | | | |
| | 5 | Peroxide cross-linked polyethylene | 1.2 | 140 | 14 | X | 0 |
| | | (Gel fraction of 90%, based on low density polyethylene) | | | | | |

In the Examples 1 and 2, the gel fraction was 0% and the component of molecular weight of not less than 300,000 are remained.

On the other hand, in the comparative examples 1, 3, and 4, the decomposition reaction of the cross link did not occur, since a radical generating substance is not added.

Further, since the reactivity is too high under a condition where the reaction temperature is high as in the comparative example 2, the decomposition reaction occurred not only in the cross-linking bond but occurred randomly, thereby decreasing the molecular weight.

Still further, when the polymer is processed at a temperature of 140° C. for a long time (i.e. 2 hours) as in the comparative example 5, the gel fraction is reduced while the molecular weight is also decreased. On the other hand, the gel fraction can be reduced without decreasing the molecular weight, by separating the process into the first step of sorbing the NO₂ and the second step of reaction as in the Examples 4 and S. Namely, it is confirmed that the oxidative reaction of preferentially cleaving the branch point of the C—C bond occurred.

According to the present invention, it is possible to use the reaction of preferentially decomposing the branch point of the C—C bond within a shorter reaction time.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A method for recycling a cross-linked polymer, in which a C—C bond of the cross-linked polymer is cleft by an oxidative decomposition reaction using a nitrogen oxide, the method comprising a step of:
keeping the cross-linked polymer in a supercritical carbon dioxide at a temperature not greater than 100° C. for 10 hours or more to preferentially oxidize a branch point of the C—C bond.

2. The method for recycling a cross-linked polymer according to claim 1, wherein the cross-linked polymer comprises a polyolefin including a tertiary carbon and a quaternary carbon, the polyolefin being cross-linked by a peroxide cross-link, an electron beam cross-link, or a silane-water cross-link.

3. The method for recycling a cross-linked polymer according to claim 1, wherein the cross-linked polymer comprises an ethylene copolymer including a tertiary carbon and a quaternary carbon, the ethylene copolymer being cross-linked by a peroxide cross-link, an electron beam cross-link, or a silane-water cross-link.

4. A method for recycling a cross-linked polymer comprising steps of:
providing the cross-linked polymer in a reaction container;
substituting an air in the reaction container for a carbon dioxide;
adding a nitrogen oxide and another carbon to the reaction container; and
keeping the reaction container under a pressure not less than a supercritical pressure of the carbon dioxide at a temperature of about 85° C. for 10 hours or more to cleave a C—C bond of the cross-linked polymer by preferentially oxidizing a branch point of the C—C bond.

5. A method for recycling a cross-linked polymer comprising steps of:
providing the cross-linked polymer in a reaction container;
substituting an air in the reaction container for a carbon dioxide;
adding a nitrogen oxide and another carbon to the reaction container;
sorbing the nitrogen oxide in the cross-linked polymer by keeping the reaction container under a pressure not greater than a supercritical pressure of the carbon dioxide to; and
reacting the cross-linked polymer with the nitrogen oxide by keeping the carbon dioxide in the reaction container under a pressure not less than the supercritical pressure of the carbon dioxide, to cleave a C—C bond of the cross-linked polymer by preferentially oxidizing a branch point of the C—C bond.

6. The method for recycling a cross-linked polymer according to claim 1, wherein the nitrogen oxide is at least one of a nitrogen dioxide and a dinitrogen tetraoxide, and a reactivity of the nitrogen oxide is controlled by adjusting the pressure and the temperature.

7. The method for recycling a cross-linked polymer according to claim 2, wherein the nitrogen oxide is at least one of a nitrogen dioxide and a dinitrogen tetraoxide, and a reactivity of the nitrogen oxide is controlled by adjusting the pressure and the temperature.

8. The method for recycling a cross-linked polymer according to claim 3, wherein the nitrogen oxide is at least one of a nitrogen dioxide and a dinitrogen tetraoxide, and a reactivity of the nitrogen oxide is controlled by adjusting the pressure and the temperature.

9. The method for recycling a cross-linked polymer according to claim 4, wherein the nitrogen oxide is at least one of a nitrogen dioxide and a dinitrogen tetraoxide, and a reactivity of the nitrogen oxide is controlled by adjusting the pressure and the temperature.

10. The method for recycling a cross-linked polymer according to claim 5, wherein the nitrogen oxide is at least one of a nitrogen dioxide and a dinitrogen tetraoxide, and a reactivity of the nitrogen oxide is controlled by adjusting the pressure and the temperature.
